(19) United States
(12) Patent Application Publication
(10) Pub. No.: US 2020/0347774 A1
(43) Pub. Date: Nov. 5, 2020

(54) CHARGE AIR COOLER

(71) Applicant: Valeo North America, Inc., Auburn Hills, MI (US)

(72) Inventors: Eduardo Barrios, Auburn Hills, MI (US); Pedro Francisco Valero, Auburn Hills, MI (US)

(73) Assignee: Valeo North America, Inc., Auburn Hills, MI (US)

(21) Appl. No.: 16/400,391

(22) Filed: May 1, 2019

(51) Int. Cl. F02B 29/04; F28F 3/02; F28F 13/12

(52) U.S. Cl. CPC F02B 29/0431; F02B 29/0437; F02B 29/0418; F02B 29/0462; F28F 13/12; F02B 29/0456; F28F 3/025

(57) ABSTRACT

A heat exchanger for providing charged air to a vehicle is described. The heat exchanger includes a plurality of heat exchange elements, and at least one passage. The plurality of heat exchange elements is stacked together in between a pair of side plates, and ends of the plurality of heat exchange elements are received in a pair of headers to configure a fluid circuit. The at least one passage is formed in a first heat exchange element amongst the plurality of heat exchange elements, along with the plurality of heat exchange elements and the first heat exchange element is formed above at least few heat exchange elements of the plurality of heat exchange elements.

### FIELD OF THE INVENTION

The present invention generally relates to heat exchangers, and in particularly, to a charge air cooler having a by-pass tube to provide optimum quantity of charged air to an engine.

### BACKGROUND

Generally, charge air coolers are provided in a vehicle to provide charged air to an engine of the vehicle. The charge air coolers receive air having a higher temperature from a turbocharger and reduce temperature of the air to a lower temperature. The charged air entering into the engine needs to be in a lower temperature to achieve optimum efficiency of the engine. Ideally, the charge air cooler includes at least two fluid circuits formed by a plurality of heat exchange elements provided in the charge air cooler. Further, a first fluid circuit is formed in such way that the air from the turbocharger passes through the plurality of heat exchange elements, whereas a second fluid circuit is formed in such a way that a cooling fluid flows around and in-between the plurality of heat exchange element. Therefore, heat exchange is possible between the air in the first fluid circuit and the cooling fluid in the second fluid circuit to achieve the charged air flowing through the first fluid circuit. Further, the plurality of heat exchange elements may include turbulators to increase pressure drop across the plurality of heat exchange elements 12 as shown in FIG. 1 so as to enhance the heat exchange between the air and the cooling fluid.

FIG. 1 illustrates a conventional charge air cooler 10 having the plurality of heat exchange elements 12. The plurality of heat exchange elements 12 is provided with the turbulators 14 to increase pressure drop of the air entering the plurality of heat exchange elements 12. The charged air is then introduced to the engine of the vehicle. However, the heat exchange elements 12 may experience icing phenomenon during winters, as the air entering the charge air cooler 10 may moisturized. The problem is aggravated in cold regions. The icing formed in the plurality of heat exchange elements 12 may block the first fluid circuit, which affects flow of air passing through the charge air cooler 10. As the turbulators 14 are disposed in the heat exchange elements 12, the quality of air passing through the heat exchange elements 12 is sub-optimum. Further, the ice formed in the turbulators 14 may block the passage of the air which affects performance of the charge air cooler, as well as it may lead to malfunction/misfire the engine due to lack of availability of optimum quantity of turbo charged air.

### SUMMARY OF THE INVENTION

Accordingly, there is a need for an assembly to provide optimum quantity of charged air to the engine while icing formed in the charge air cooler is blocking the first fluid circuit.

In the present description, some elements or parameters may be indexed, such as a first element and a second element. In this case, unless stated otherwise, this indexation is only meant to differentiate and name elements which are similar but not identical. No idea of priority should be inferred from such indexation, as these terms may be switched without betraying the invention. Additionally, this indexation does not imply any order in mounting or use of the elements of the invention.

In view of the foregoing, an embodiment of the invention herein provides a heat exchanger for providing charged air to an engine of a vehicle. The heat exchanger includes a plurality of heat exchange elements, and at least one passage. The plurality of heat exchange elements is stacked together in between a pair of side plates, and ends of the plurality of heat exchange elements are received in a pair of headers to configure a fluid circuit. The at least one passage is formed in a first heat exchange element amongst the plurality of heat exchange elements, extending along with the plurality of heat exchange elements and the first heat exchange element is formed above at least few heat exchange elements of the plurality of heat exchange elements.

In one embodiment, the fluid circuit is configured to enable flow of charged air into the plurality of the heat exchange elements.

In another embodiment, the heat exchanger includes an inlet adapted to coupled to a first header amongst the pair of headers to introduce the charged air to the plurality of heat exchange elements, and an outlet adapted to coupled to a second header amongst the pair of headers to receive the charged air from the plurality of heat exchange elements.

In yet another embodiment, the heat exchanger further includes a fin pattern formed between adjacent heat exchange elements of the plurality of heat exchange elements to enable heat exchange between the charged air in the first fluid circuit and ambient air flowing around the plurality of heat exchange elements.

In yet another embodiment, the heat exchanger further includes turbulators disposed in the plurality of heat exchange elements, except in the first heat exchange element, to cause pressure drop of the charged air flowing through the plurality of heat exchange elements and the turbulators are formed by one shot brazing process.

Generally, the at least one passage being a rectangular passage, is brazed in the first heat exchange element by one shot brazing process. The at least one passage has a brazing surface to enable brazing between the at least one passage and the first heat exchange element and to provide reinforcement to the at least one passage to resist pressure cycle and thermal cycle resistance. In another embodiment, the at least one passage is adapted to enable flow of the charged air there-through while the turbulators in the plurality of heat exchange elements are blocked by icing phenomenon.

In one embodiment, the plurality of heat exchange elements is folded tubes. The first heat exchange element is formed at a top of the plurality of heat exchange elements

### BRIEF DESCRIPTION OF THE DRAWINGS

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates a schematic view of a conventional charge air cooler, showing an embodiment from a prior art;

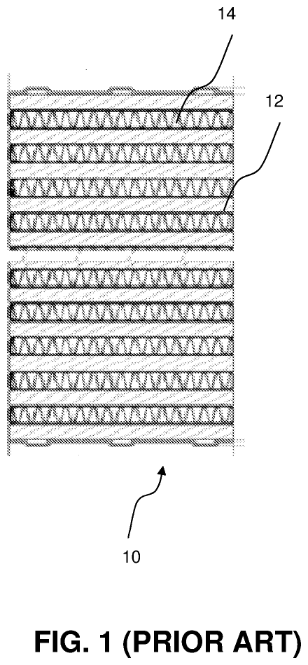

FIG. 2A illustrate a schematic view of a heat exchanger, in accordance with an embodiment of the present invention;

FIG. 2B illustrates a section view of the heat exchanger of FIG. 2A;

FIGS. 3A-3B illustrate a pair of headers connected with a pair of side plates of a first heat exchange element of FIG. 2A; and

FIG. 4 illustrate a schematic view of the plurality of heat exchange elements extended between the first header and the second header of FIG. 2A.

It must be noted that the figures disclose the invention in a detailed enough way to be implemented, the figures helping to better define the invention if needs be. The invention should however not be limited to the embodiment disclosed in the description.

### DETAILED DESCRIPTION

The present invention relates to a heat exchanger, particularly to a charge air cooler, for providing optimum quantity of charged air to an engine of a vehicle. Conventional charge air coolers may experience blockage of air in heat exchange elements due to icing of moisturized air in the winter season, which affects performance of the engine and may misfire the engine. To overcome such shortcomings, the proposed heat exchanger is provided with a by-pass passage. The present heat exchanger includes a plurality of heat exchange elements extended between a pair of headers. Further, a passage is provided on a first heat exchange element amongst the plurality of heat exchange elements to enable flow of air through the passage while air-flow through other heat exchange elements is restricted or blocked by icing phenomenon. The first heat exchange element is at a top of the plurality of heat exchange elements. In other words, the first heat exchange element is formed on top of other heat exchange elements. As the first heat exchange element is at top of other heat exchange elements, the charged air can passes through the passage while other heat exchange elements are at least partially blocked by icing phenomenon. Further, the icing is formed due to moisture content in the air entering into the heat exchanger, and the icing forms in the bottom portion of the heat exchanger due to density of water molecules, hence the top most of the heat exchanger element is used for providing the by-pass passage for the charged air.

While aspects relating to a passage provided in a top portion of heat exchanger elements to provide charged air to an engine as described above and henceforth can be implemented in any heat exchange elements, the embodiments are described in the context of the following system(s).

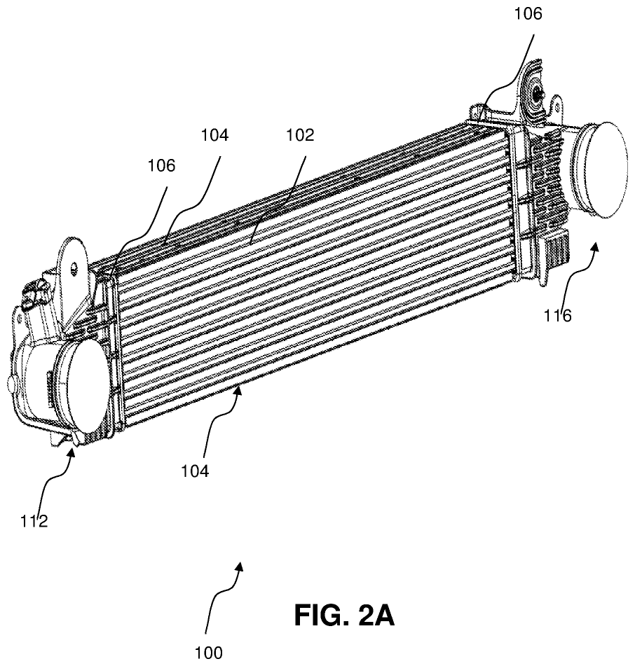

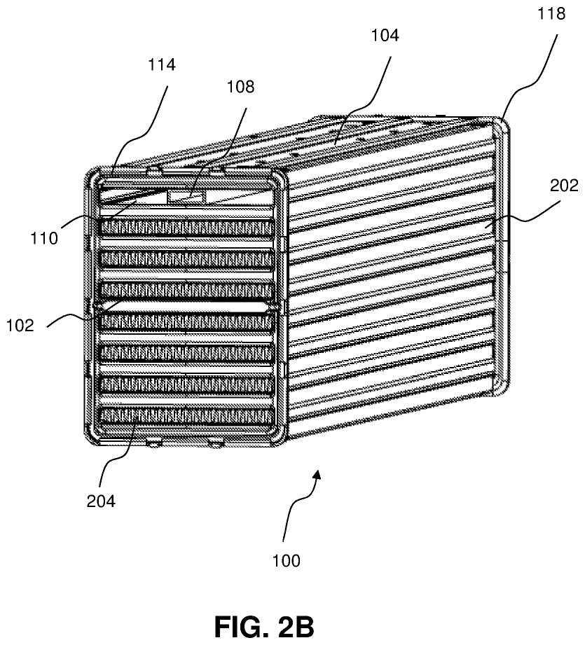

FIGS. 2A and 2B illustrate schematic views of a heat exchanger 100, in accordance with an embodiment of the present invention. In one example, FIG. 2A illustrates a schematic view of the heat exchanger 100, and FIG. 2B illustrates a section view of the heat exchanger 100. The heat exchanger 100 is a charger air cooler to provide optimum quantity of cooled charged air to an engine of a vehicle. Generally, the heat exchanger 100, hereinafter referred to as charge air cooler, is provided in the downstream of a compressor of a Heating Ventilation and Air-conditioning system. The charge air cooler 100 may receive the hot charged air from the compressor or a turbo-charger based on the placement of the charge air cooler 100. The charge air cooler 100 receives air from the compressor and introduces the air to the engine. The heat exchanger 100, includes a plurality of heat exchange elements 102 stacked together in between a pair of side plates 104. In other words, the plurality of heat exchange elements 102 is disposed in between the pair of side plates in such a way that one heat exchange element is layered over another heat exchange element. The charge air cooler 100 further includes a pair of headers 106 adapted to receive ends of the plurality of heat exchange elements 102. In other words, the plurality of heat exchange elements 102 is extended between the pair of headers 106. In one embodiment, the plurality of heat exchange elements 102 is any one of folded tubes, heat tubes, and heat plates.

The charge air cooler 100 further includes at least one passage 108 formed in a first heat exchange element 110 amongst the plurality of heat exchange elements 102, along with the plurality of heat exchange elements 102. In one embodiment, the first heat exchange element 110 is a heat exchange element formed above at least few heat exchange elements of the plurality of heat exchange elements 102. In another embodiment, the first heat exchange element 110 is a top heat exchange element of the plurality of heat exchange element 102. The plurality of heat exchange elements 102 is adapted to exchange heat from air passing through the plurality of heat exchange elements 102 with the ambient air. In one embodiment, the charge air cooler 100 may include a first fluid circuit formed by the plurality of heat exchange element 102 and a second fluid circuit. For instance, the first fluid circuit has a first fluid flow there-through, and the second fluid circuit has a second fluid flow there-through. The first fluid flow can be hot air received from a turbocharger or a compressor and the second fluid flow can be ambient air or water-glycol mixture based on the type of the charge air cooler. For example, the second fluid flow can be water or water-glycol mixture in case the charge air cooler 100 is a water-cooled charge air cooler, or can be ambient air in case the charge air cooler 100 is an air-cooled charge air cooler. In one example, the first fluid may flow through the plurality of heat exchange elements 102, and the second fluid may be flowing around and in-between adjacent heat exchange elements of the plurality of heat exchange elements 102.

The charge air cooler 100 further includes an inlet 112 and an outlet 116 to introduce the first fluid to and receive the first fluid from the plurality of heat exchange elements 102 respectively. Further, the first fluid and air are interchangeably used throughout the specification. For instance, the inlet 112 is coupled to a first header 114 amongst the pair of headers 106 to introduce the air to the plurality of heat exchange elements 102, and the outlet 116 is coupled to a second header 118 amongst the pair of headers 106 to receive the air from the plurality of heat exchange elements 102. Further, a fin pattern 202 is formed between the adjacent heat exchange elements of the plurality of heat exchange elements 102 to enable heat exchange between the first fluid in the first fluid circuit and the ambient air/water flowing around the plurality of heat exchange elements 102. In other words, the fin pattern 202 radiates heat from the first fluid flowing through the plurality of heat exchange elements 102 to the second fluid flowing around the plurality of heat exchange elements 102 to obtain cold first fluid.

The plurality of heat exchange elements 102 further includes turbulators 204 that are disposed in the plurality of heat exchange elements 102, except in the first heat exchange element 110. In other words, the first heat exchange element 110 is a hollow element and include the at least one passage 108 alone, whereas other heat exchange elements of the plurality of heat exchange elements 102 are provided with the turbulators 204. The turbulators 204 are provided in the plurality of heat exchange elements 102 to increase pressure drop of the first fluid flowing through the plurality of heat exchange elements 102 and improve the heat transfer between the first fluid flowing inside the plurality of heat exchanger elements 102 and the second fluid flowing outside the plurality of heat exchanger elements 102. In other words, the turbulators 204 reduces the flow speed of the first fluid flowing through the plurality of heat exchange elements 102 to achieve optimum heat exchange between the first fluid and the second fluid. In one embodiment, the first fluid, for example charged air, received from the compressor or turbocharger is having a higher temperature and higher pressure, so the charge air cooler 100 may experience high pressure inside the plurality of heat exchange elements 102. The high pressure charged air may deforms the plurality of heat exchange elements 102. To avoid such deformation of the plurality of heat exchange elements 102, the turbulators 204 are disposed in the plurality of heat exchange elements 102. In addition, the turbulators 204 provide reinforcement to the plurality of heat exchange elements 102. In one embodiment, the turbulators 204 are formed by one shot brazing process in the plurality of heat exchange elements 102.

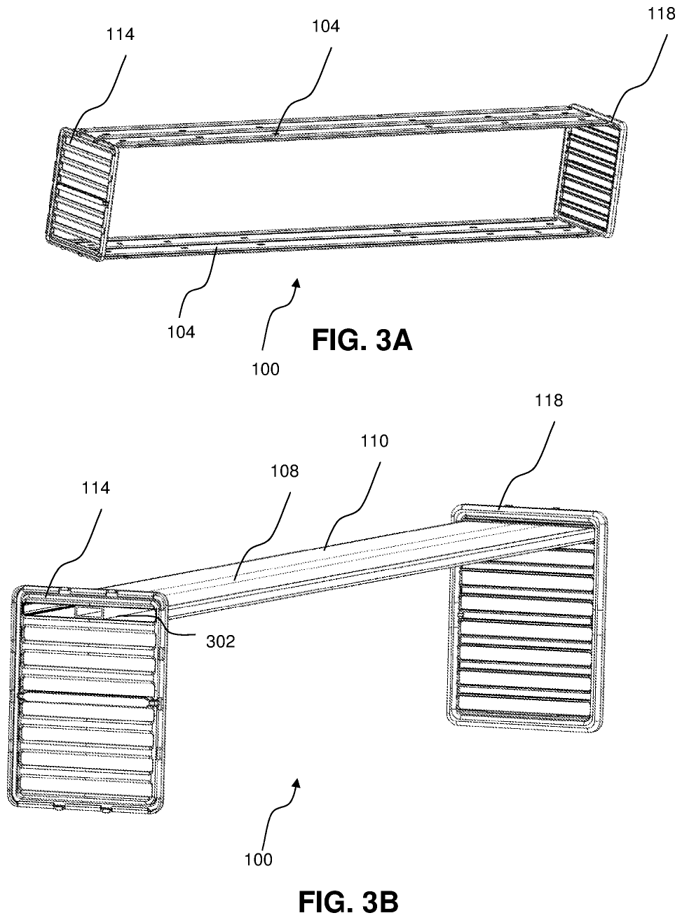

FIGS. 3A-3B illustrate another view of the pair of headers 106 with the pair of side plates 104 and the first heat exchange element 110, in accordance with an embodiment of the present invention. In one example, FIG. 3A illustrates the pair of side plates 104 extending between the first header 114 and the second header 118 of the pair of headers 106, and FIG. 3B illustrates the first heat exchange element 110 extended between the first header 114 and the second header 118. The pair of side plates 104 provides rigid support to the plurality of heat exchange elements 102 stacked there-between. The pair of side plates 104 may be crimped to the pair of headers 106 to configure connection between the pair of headers 106. Further, the first heat exchange element 110 may have a rectangular hollow section having the at least one passage 108 therein. In one embodiment, the at least one passage 108 is a rectangular passage brazed in the first heat exchange element 110 by one shot brazing process. The at least one passage 108 may include a brazing surface 302 to enable brazing between the at least one passage 108 and the first heat exchange element 110. The brazing surface 302 provides reinforcement to the at least one passage 108 to resist pressure cycle and thermal cycle. In one embodiment, the first heat exchange element 110 may be crimped to the first header 114 and the second header 118 to configure connection between the pair of headers 106.

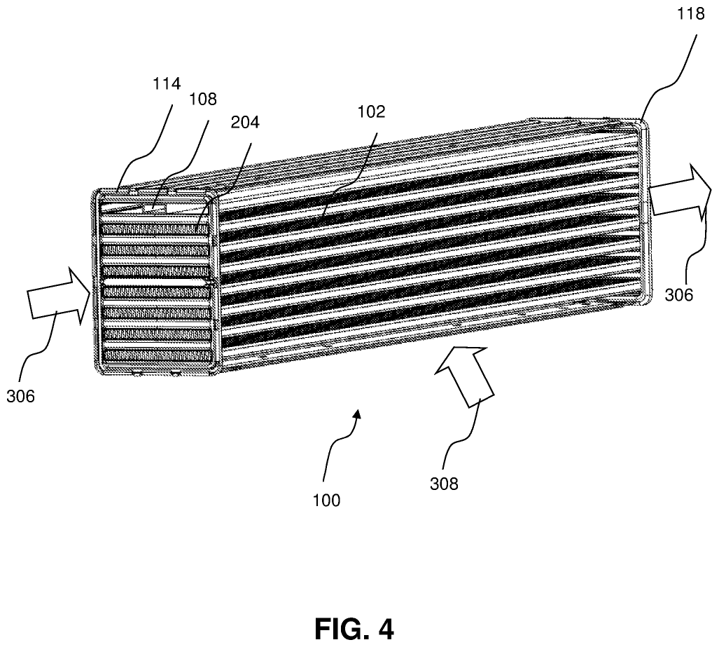

FIG. 4 illustrates a schematic representation of the plurality of heat exchange elements 102 extending between the first header 114 and the second header 118. The first fluid received from the compressor enters and passes through the first header 114 and egresses through the second header 118 as shown by flow arrow 306, whereas the second fluid flows around the plurality of heat exchange elements 102 as depicted by the flow arrow 308 in the charge air cooler 100. During winter season, the first fluid or the second fluid may include moisture content in it that may condense due to lower ambient temperature. The condensed fluid may be formed on the turbulators 204 of the plurality of heat exchange elements 102, thereby blocking the passage of the charged air i.e., the first fluid, to pass through the plurality of heat exchange elements 102. As the passage of the charged air in the plurality of heat exchange elements 102 is blocked either partially or completely, the charged air reaching the engine is sub-optimum, which affects performance of the engine. To provide optimum quantity of charged air to the engine, the at least one passage 108 is provided in the charge air cooler 100. The at least one passage allows the charged air to pass through the charge air cooler 100 and exchange heat with the second fluid, when the plurality of the heat exchange elements 102 is blocked either partially or completely by condensed moisture or icing. Therefore, the engine is supplied with the charged air even-though there are blockages in the turbulators 204 in the charge air cooler 100. The at least one passage 108 is always formed in the top portion of the plurality of heat exchange elements 102, since the icing/condensed moisture forms in the bottom portion of the plurality of heat exchange elements due to its density.

The at least one passage 108 is also referred to as a by-pass tube that allows the charged air to flow though the charged air cooler, when most of the heat exchange elements 102 are at least partially blocked, to avoid engine misfire and engine malfunction. Further, the at least one passage 108 provides structural support to meet durability specifications such as Pressure Cycle test, Burst test, and Thermal cycle. Further, the at least one passage 108 improves stiffness of the first heat exchange element 110 since the at least one passage 108 is working as an additional reinforcement inside the first heat exchange element 110. The at least one passage 108 supports deformations effect of the charge air cooler 100 under Air and Coolant pulsation pressures and vibrations, and mitigate packaging constrain of the charge air cooler 100. Also the at least one passage 108 enables distribution of the first fluid in the plurality of heat exchange elements 102 without any changes of the plurality of heat exchange elements 102. Although, the at least one passage 108 is explained with respect to the charged air cooler 100, it can implemented in any other heat exchanger experiencing icing phenomenon.

In any case, the invention cannot and should not be limited to the embodiments specifically described in this document, as other embodiments might exist. The invention shall spread to any equivalent means and any technically operating combination of means.

What is claimed is:

1. A heat exchanger for providing charged air to an engine of a vehicle, comprising:
a plurality of heat exchange elements stacked together in between a pair of side plates, wherein ends of the plurality of heat exchange elements are received in a pair of headers to configure a fluid circuit; and
at least one passage formed in a first heat exchange element amongst the plurality of heat exchange elements, extending along with the plurality of heat exchange elements, wherein the first heat exchange element is formed above at least few heat exchange elements of the plurality of heat exchange elements.

2. The heat exchanger as claimed in claim 1, wherein the fluid circuit is configured to enable flow of charged air into the plurality of the heat exchange elements.

3. The heat exchanger as claimed in claim 2, further comprising:
an inlet adapted to coupled to a first header amongst the pair of headers to introduce the charged air to the plurality of heat exchange elements; and
an outlet adapted to coupled to a second header amongst the pair of headers to receive the charged air from the plurality of heat exchange elements.

4. The heat exchanger as claimed in claim 1, further comprising: a fin pattern formed between adjacent heat exchange elements of the plurality of heat exchange elements to enable heat exchange between the charged air in the first fluid circuit and ambient air flowing around the plurality of heat exchange elements.

5. The heat exchanger as claimed in claim 1, further comprising: turbulators disposed in the plurality of heat exchange elements, except in the first heat exchange element, to cause pressure drop of the charged air flowing through the plurality of heat exchange elements.

6. The heat exchanger as claimed in claim 5, wherein the turbulators are connected to inside walls of the plurality of heat exchange elements by one shot brazing process.

7. The heat exchanger as claimed in claim 1, wherein the at least one passage being a rectangular passage, is brazed in the first heat exchange element by one shot brazing process.

8. The heat exchanger as claimed in claim 1, wherein the plurality of heat exchange elements is folded tubes.

9. The heat exchanger as claimed in claim 7, wherein the at least one passage has a brazing surface to enable brazing between the at least one passage and the first heat exchange element and to provide reinforcement to the at least one passage to resist pressure cycle and thermal cycle resistance.

10. The heat exchanger as claimed in claim 1, wherein the at least one passage is adapted to enable flow of the charged air there-through while the turbulators in the plurality of heat exchange elements are blocked by icing phenomenon.

11. The heat exchanger as claimed in claim 1, wherein the first heat exchange element is formed at a top of the plurality of heat exchange elements.
